(19) United States
(12) Patent Application Publication
(10) Pub. No.: US 2026/0370839 A1
(43) Pub. Date: Nov. 19, 2026

(54) Methods and Apparatus of Prioritized Initial Motion Vector for Decoder-side Motion Refinement in Video Coding

(71) Applicant: MEDIATEK INC., Hsinchu City (TW)

(72) Inventors: Chih-Hsuan LO, Hsinchu City (TW); Shih-Chun CHIU, Hsinchu City (TW); Tzu-Der CHUANG, Hsinchu City (TW); Ching-Yeh CHEN, Hsinchu City (TW); Yi-Wen CHEN, San Jose, CA (US); Chih-Wei HSU, Hsinchu City (TW); Olena CHUBACH, San Jose, CA (US)

(21) Appl. No.: 19/155,366

(22) PCT Filed: Feb. 7, 2024
(86) PCT No.: PCT/CN2024/076721

§ 371 Date: Aug. 11, 2025

Related U.S. Application Data
(60) Provisional application No. 63/484,546, filed on Feb. 13, 2023.
(60) Provisional application No. 63/495,779, filed on Apr. 13, 2023.
(60) Provisional application No. 63/497,754, filed on Apr. 24, 2023.

(51) Int. Cl. H04N 19/137; H04N 19/176

(52) U.S. Cl. CPC H04N 19/137; H04N 19/176

(57) ABSTRACT

A method and apparatus for video coding using prioritized initial MV. According to one method, an initial TM cost associated with an initial MV is derived based on a current template of the current block and a first template of a first reference block pointed by the initial MV. The initial TM cost is modified by adding an offset value. One or more candidate TM costs for one or more MV candidates are determined based on the current template of the current block and one or more second templates respectively. Each of the second templates is associated with a second reference block pointed by an MV candidate. The initial MV and said one or more MV candidates are reordered according to the modified initial TM cost and said one or more candidate TM costs. According to another method, weighted candidate TM costs are used for reordering.

### CROSS REFERENCE TO RELATED APPLICATIONS

The present invention is a non-Provisional Application of and claims priority to U.S. Provisional Patent Application No. 63/484,546, filed on Feb. 13, 2023, U.S. Provisional Patent Application No. 63/495,779, filed on Apr. 13, 2023 and U.S. Provisional Patent Application No. 63/497,754, filed on Apr. 24, 2023. The U.S. Provisional Patent Applications are hereby incorporated by reference in their entireties.

### FIELD OF THE INVENTION

The present invention relates to video coding. In particular, the present invention relates to prioritized initial motion vector among a set of motion vector candidates to favour the initial motion vector in a video coding system.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In High-Efficient Video Coding standard (HEVC), pictures are divided into a sequence of coding tree units (CTUs). A CTU consists of an N×N block of luma samples together with two corresponding blocks of chroma samples for a picture that has three sample arrays, or an N×N block of samples of a monochrome plane in a picture that is coded using three separate colour planes. The CTU concept is broadly analogous to that of the macroblock in previous standards such as Advanced Video Coding (AVC). The maximum allowed size of the luma block in a CTU is specified to be 64×64 in Main profile. A CTU is split into CUs by using a quaternary-tree structure denoted as coding tree to adapt to various local characteristics. The decision whether to code a picture area using inter-picture (temporal) or intra-picture (spatial) prediction is made at the leaf CU level. Each leaf CU can be further split into one, two or four Prediction Units (PUs) according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

In FIG. 3 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

For each inter-predicted CU, motion parameters consists of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

ITU-T VCEG (Q6/16) and ISO/IEC MPEG (JTC 1/SC 29/WG 5) are studying the potential need for standardization of future video coding technology with a compression capability that significantly exceeds that of the current VVC standard. The Enhanced Compression Model (ECM) reference software is provided to demonstrate a reference implementation of encoding techniques and the decoding process for JVET Enhanced compression beyond VVC capability exploration work. The reference software can be accessed via https://vcgit.hhi.fraunhofer.de/ecm/ECM.git. ECM basically is the successor to VVC and thus it shares many common parts as VVC.

In HEVC, for each inter PU, one of three prediction modes including inter, skip, and merge, can be selected. Generally speaking, a motion vector competition (MVC) scheme is introduced to select a motion candidate from a given candidate set that includes spatial and temporal motion candidates. Multiple references to the motion estimation allows finding the best reference in 2 possible reconstructed reference picture list (namely List 0 and List 1). For the inter mode (unofficially termed AMVP mode, where AMVP stands for advanced motion vector prediction), inter prediction indicators (List 0, List 1, or bi-directional prediction), reference indices, motion candidate indices, Motion Vector Differences (MVDs) and prediction residual are transmitted. As for the skip mode and the merge mode, only merge indices are transmitted, and the current PU inherits the inter prediction indicator, reference indices, and motion vectors from a neighbouring PU referred by the coded merge index. In the case of a skip coded CU, the residual signal is also omitted.

In VVC, AMVP mode is further improved by the new modes such as symmetric motion vector difference (SMVD) mode, adaptive motion vector resolution (AMVR) and affine AMVP mode; Merge/Skip modes are further improved by enhanced merge candidates, combined inter-intra prediction (CIIP), affine merge mode, subblock temporal motion vector predictor (SbTMVP), merge mode with Motion Vector Difference (MMVD) and Geometric Partition Mode (GPM). In VVC, a decoder-side motion vector refinement (DMVR), Bi-Directional Optical Flow (BDOF) and Prediction Refinement with Optical Flow (PROF) are utilized to refine the motion vectors or the motion-compensated predictors at the decoder.

In ECM, several new coding tools are developed to further improve the AMVP, Merge and Skip mode such as Bilateral matching AMVP-Merge mode, multi-hypothesis prediction (MHP), overlapped block motion compensation (OBMC) and so on. Furthermore, template matching based decoder side motion vector refinement is also proposed to enhanced the coding efficiency of the inter prediction.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16th luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

After VVC is finalized, the Enhanced Compression Model (ECM) reference software is developed to study the potential need for standardization of future video coding technology. In current ECM, several inter-prediction coding tools are included to provide further BD-rate savings:
Local illumination compensation (LIC)
Non-adjacent spatial candidate
Template Matching (TM)
Overlapped Block Motion Compensation (OBMC)
Multi-hypothesis prediction (MHP)
Bilateral matching AMVP-Merge Mode
and so some other tools under development

The following text provides the details on some selected inter prediction methods specified in VVC and ECM.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merge candidate lists (or called as merging candidate lists) for all CUs within a certain size of area.

### History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained First-In-First-Out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates can be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. The last two entries in the table are redundancy checked to A₁ and B₁ spatial candidates, respectively.
2. Once the total number of available merge candidates reaches the maximally allowed merge candidates minus 1, the merge candidate list construction process from HMVP is terminated.

### Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered

Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.

Distance index specifies motion magnitude information and indicates the pre-defined offset from the starting points (412 and 422) for an L0 reference block 410 and L1 reference block 420. As shown in FIG. 4, an offset is added to either horizontal component or vertical component of the starting MV, where small circles in different styles correspond to different offsets from the centre. The relation of distance index and pre-defined offset is specified in Table 1.

TABLE 1
The relation of distance index and pre-defined offset

| Distance IDX | 0 | 1 | 2 | 3 | 4 | 5 | 6 | 7 |
|---|---|---|---|---|---|---|---|---|
| Offset (in unit of luma sample) | ¼ | ½ | 1 | 2 | 4 | 8 | 16 | 32 |

Direction index represents the direction of the MVD relative to the starting point. The direction index can represent of the four directions as shown in Table 2. It's noted that the meaning of MVD sign can be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 2 specifies the sign of MV offset added to the list0 MV component of starting MV and the sign for the list1 MV has opposite value. Otherwise, if the difference of POC in list 1 is greater than list 0, the sign in Table 2 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described. If the POC difference of L1 is greater than L0, the MVD for list 0 is scaled in the same way. If the starting MV is uni-predicted, the MVD is added to the available MV.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### Affine Motion Compensated Prediction

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. As shown FIGS. 5A-B, the affine motion field of the block 510 is described by motion information of two control point (4-parameter) in FIG. 5A or three control point motion vectors (6-parameter) in FIG. 5B.

For 4-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{1 y} - m {v}_{0 y}}{W} y + m {v}_{0 x} \\ m {v}_{y} = \frac{m {v}_{1 y} - m {v}_{0 y}}{W} x + \frac{m {v}_{1 y} - m {v}_{0 x}}{W} y + m {v}_{0 y}\end{matrix} \qquad ( 1 )$$

For 6-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad ( 2 )$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.

In order to simplify the motion compensation prediction, block based affine transform prediction is applied. To derive motion vector of each 4×4 luma subblock, the motion vector of the centre sample of each subblock, as shown in FIG. 6, is calculated according to above equations, and rounded to 1/16 fraction accuracy. Then, the motion compensation interpolation filters are applied to generate the prediction of each subblock with the derived motion vector. The subblock size of chroma-components is also set to be 4×4. The MV of a 4×4 chroma subblock is calculated as the average of the MVs of the top-left and bottom-right luma subblocks in the collocated 8×8 luma region.

As is for translational-motion inter prediction, there are also two affine motion inter prediction modes: affine merge mode and affine AMVP mode.

### Affine Merge Prediction

AF_MERGE mode can be applied for CUs with both width and height larger than or equal to 8. In this mode, the CPMVs (Control Point MVs) of the current CU is generated based on the motion information of the spatial neighbouring CUs. There can be up to five CPMVP (CPMV Prediction) candidates and an index is signalled to indicate the one to be used for the current CU. The following three types of CPVM candidate are used to form the affine merge candidate list:
Inherited affine merge candidates that are extrapolated from the CPMVs of the neighbour CUs
Constructed affine merge candidates CPMVPs that are derived using the translational MVs of the neighbour CUs
Zero MVs

In VVC, there are two inherited affine candidates at most, which are derived from the affine motion model of the neighbouring blocks, one from left neighbouring CUs and one from above neighbouring CUs. The candidate blocks are shown in FIG. 7 for current block 710. For the left predictor, the scan order is A₀→A₁, and for the above predictor, the scan order is B0→B₁→B₂. Only the first inherited candidate from each side is selected. No pruning check is performed between two inherited candidates. When a neighbouring affine CU is identified, its control point motion vectors are used to derived the CPMVP candidate in the affine merge list of the current CU. As shown in FIG. 8, if the neighbouring left bottom block A of the current block 810 is coded in affine mode, the motion vectors v₂, v₃ and v₄ of the top left corner, above right corner and left bottom corner of the CU 820 containing block A are attained. When block A is coded with 4-parameter affine model, the two CPMVs of the current CU (i.e., v₀ and v₁) are calculated according to v₂, and v₃. In case that block A is coded with 6-parameter affine model, the three CPMVs of the current CU are calculated according to v₂, v₃ and v₄.

Constructed affine candidate means the candidate is constructed by combining the neighbouring translational motion information of each control point. The motion information for the control points is derived from the specified spatial neighbours and temporal neighbour for a current block 910 as shown in FIG. 9. CPMVₖ (k=1, 2, 3, 4) represents the k-th control point. For CPMV₁, the B2→B3→A2 blocks are checked and the MV of the first available block is used. For CPMV₂, the B1→B0 blocks are checked and for CPMV₃, the A1→A0 blocks are checked. For TMVP is used as CPMV₄ if it's available.

After MVs of four control points are attained, affine merge candidates are constructed based on the motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### Decoder Side Motion Vector Refinement (DMVR) in VVC

In order to increase the accuracy of the MVs of the merge mode, a bilateral-matching (BM) based decoder side motion vector refinement is applied in VVC. In bi-prediction operation, a refined MV is searched around the initial MVs (1032 and 1034) in the reference picture list L0 1012 and reference picture list L1 1014 for a current block 1020 in the current picture 1010. The collocated blocks 1022 and 1024 in L0 and L1 are determined according to the initial MVs 1030 and 1032) and the location of the current block 1020 in the current picture as shown in FIG. 10. The BM method calculates the distortion between the two candidate blocks (1042 and 1044) in the reference picture list L0 and list L1. The locations of the two candidate blocks (1042 and 1044) are determined by adding two opposite offset (1062 and 1064) to the two initial MVs (1032 and 1034) to derive the two candidate MVs (1052 and 1054). As illustrated in FIG. 10, the SAD (Sum of Absolute Differences) between the candidate blocks (1042 and 1044) based on each MV candidate around the initial MV (1032 or 1034) is calculated. The MV candidate (1052 or 1054) with the lowest SAD becomes the refined MV and used to generate the bi-predicted signal.

In VVC, the application of DMVR is restricted and is only applied for the CUS which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by the DMVR process is used to generate the inter prediction samples and also used in temporal motion vector prediction for future pictures coding. While the original MV is used in the deblocking process and also used in spatial motion vector prediction for future CU coding.

The additional features of DMVR are mentioned in the following sub-clauses.

### Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

When this mode is used, a CU is split into two parts by a geometrically located straight line as shown in FIG. 11. The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights. This is the prediction signal for the whole CU, and transform and quantization process will be applied to the whole CU as in other prediction modes. Finally, the motion field of a CU predicted using the geometric partition modes is stored.

### Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value wt is calculated depending on the coding modes of the top and left neighbouring blocks (as shown in FIG. 12) of current CU 1210 as follows:
If the top neighbour is available and intra coded, then set isIntraTop to 1, otherwise set isIntraTop to 0;
If the left neighbour is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

P_{CIIP}=((4−wt)*Pᵢₙₜₑᵣ+wt*Pᵢₙₜᵣₐ+2)>>2 (3)

### Template Matching (TM)

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. As illustrated in FIG. 13, a better MV is searched around the initial motion of the current CU within a [−8, +8]-pel search range. In FIG. 13, rows of pixels 1314 above current block and columns of pixels 1316 to the left of the current block 1312 in the current picture 1310 (only a partial picture area shown) are selected as the template. The search starts from an initial position (as identified by the initial MV 1330) in the reference picture. Corresponding rows of pixels 1324 above the reference block 1322 and columns of pixels 1326 to the left of the reference block 1322 in the reference picture 1320 (only a partial picture area shown) are identified as shown in FIG. 13. The [−8, +8]-pel search range 1340 is indicated by a dashed square.

The template matching method in JVET-J0021 (Yi-Wen Chen, et al., “Description of SDR, HDR and 360° video coding technology proposal by Qualcomm and Technicolor-low and high complexity versions”, Joint Video Exploration Team (JVET) of ITU-T SG 16 WP 3 and ISO/IEC JTC 1/SC 29/WG 11, 10th Meeting: San Diego, US, 10-20 Apr. 2018, Document: JVET-J0021) is used with the following modifications: search step size is determined based on AMVR mode and TM can be cascaded with bilateral matching process in merge modes.

In AMVP mode, an MVP candidate is determined based on template matching error to select the one which reaches the minimum difference between the current block template and the reference block template, and then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 3. This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

TABLE 3
Search patterns of AMVR and merge mode with AMVR

| | AMVR mode | | | | | |
|---|---|---|---|---|---|---|
| | 4- | Full- | Half- | Quarter- | Merge mode | |
| Search pattern | pel | pel | pel | pel | AltIF = 0 | AltIF = 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In merge mode, similar search method is applied to the merge candidate indicated by the merge index. As shown in Table 3, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

### Overlapped Block Motion Compensation (OBMC)

When OBMC is applied, top and left boundary pixels of a CU are refined using neighbouring block's motion information with a weighted prediction as described in JVET-L0101 (Zhi-Yi Lin, et al., “CE10.2.1: OBMC”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0101).

Conditions of not applying OBMC are as follows:
When OBMC is disabled at SPS level
When current block has intra mode or IBC mode
When current block applies LIC
When current luma block area is smaller or equal to 32

A subblock-boundary OBMC is performed by applying the same blending to the top, left, bottom, and right subblock boundary pixels using neighbouring subblocks' motion information. It is enabled for the subblock based coding tools:
Affine AMVP modes;
Affine merge modes and subblock-based temporal motion vector prediction (SbTMVP);
Subblock-based bilateral matching.

When OBMC mode is used in CIIP mode with LMCS, inter blending is performed prior to LMCS mapping of inter samples. LMCS is applied to blended inter samples which are combined with LMCS applied intra samples in CIIP mode,

$$Inte {r}_{p r e d Y}^{′} = \frac{( 128 - {w}_{1} ) \times Inte {r}_{p r e d Y} + {w}_{1} \times OBM {C}_{p r e d Y}}{128}$$

$$PredY = \frac{( 4 - {w}_{0} ) \times FwdM ap ( Inte {r}_{p r e d Y}^{′} ) + {w}_{0} \times Intr {a}_{p r e d Y}}{4}$$

where Inter_{predY} represents the samples predicted by the motion of current block in the original domain, Intra_{predY} represents the samples predicted in the mapped domain, OBMC_{predY} represents the samples predicted by the motion of neighboring blocks in the original domain, and w₀ and w₁ are the weights.

### Template Matching Based OBMC

In template matching based OBMC scheme, instead of directly using the weighted prediction, the prediction value of CU boundary samples derivation approach is decided according to the template matching costs, including using current block's motion information only, or using neighbouring block's motion information as well with one of the blending modes.

In this scheme for each block with a size of 4×4 at the top CU boundary, the above template size equals to 4×1. If N adjacent blocks have the same motion information, then the above template size is enlarged to 4N×1 since the MC operation can be processed at one time. For each left block with a size of 4×4 at the left CU boundary, the left template size equals to 1×4 or 1×4N as shown in FIG. 14. In FIG. 14, box 1410 corresponds to a CU. If N adjacent blocks have the same motion information, then the above template size is enlarged to 4N×1 since the MC operation can be processed at one time, which is in the same manner in ECM-OBMC. For each left block with a size of 4×4 at the left CU boundary, the left template size equals to 1×4 or 1×4N.

For each 4×4 top block (or N 4×4 blocks group), the prediction value of boundary samples is derived according to the following steps:
Take block A as the current block and its above neighbouring block AboveNeighbour_A for example. The operation for left blocks is conducted in the same manner.
First, three template matching costs (Cost1, Cost2, Cost3) are measured by SAD between the reconstructed samples of a template and its corresponding reference samples derived by MC process according to the following three types of motion information:
   i. Cost1 is calculated according to A's motion information.
   ii. Cost2 is calculated according to AboveNeighbour_A's motion information.
   iii. Cost3 is calculated according to weighted prediction of A's and AboveNeighbour_A's motion information with weighting factors as ¾ and ¼ respectively.
Second, choose one out of three approaches to calculate the final prediction results of boundary samples by comparing Cost1, Cost2 and Cost 3.

The original MC result using current block's motion information is denoted as Pixel1, and the MC result using neighbouring block's motion information is denoted as Pixel2. The final prediction result is denoted as NewPixel.
If Cost1 is minimum, then NewPixel(i, j)=Pixel1 (i, j).
If (Cost2+(Cost2>>2)+(Cost2>>3))<=Cost1, then blending mode 1 is used.

For luma blocks, the number of blending pixel rows is 4.

NewPixel(i,0)=(26×Pixel1(i,0)+6×Pixel2(i,0)+16)>>5

NewPixel(i,1)=(7×Pixel1(i,1)+Pixel2(i,1)+4)>>3

NewPixel(i,2)=(15×Pixel1(i,2)+Pixel2(i,2)+8)>>4

NewPixel(i,3)=(31×Pixel1(i,3)+Pixel2(i,3)+16)>>5

For chroma blocks, the number of blending pixel rows is 1.

NewPixel(i,0)=(26×Pixel1(i,0)+6×Pixel2(i,0)+16)>>5

If Cost1<=Cost2, then blending mode 2 is used.
For luma blocks, the number of blending pixel rows is 2.

NewPixel(i,0)=(15×Pixel1(i,0)+Pixel2(i,0)+8)>>4

NewPixel(i,1)=(31×Pixel1(i,1)+Pixel2(i,1)+16)>>5

For chroma blocks, the number of blending pixel rows/columns is 1.

NewPixel(i,0)=(15×Pixel1(i,0)+Pixel2(i,0)+8)>>4
Otherwise, blending mode 3 is used.

For luma blocks, the number of blending pixel rows is 4.

NewPixel(i,1)=(7×Pixel1(i,1)+Pixel2(i,1)+4)>>3

NewPixel(i,2)=(15×Pixel1(i,2)+Pixel2(i,2)+8)>>4

NewPixel(i,3)=(31×Pixel1(i,3)+Pixel2(i,3)+16)>>5

For chroma blocks, the number of blending pixel rows is 1.

NewPixel(i,0)=(7×Pixel1(i,0)+Pixel2(i,0)+4)>>3.

Geometric Partitioning Mode (GPM) with Template Matching (TM)

Template matching is applied to GPM. When GPM mode is enabled for a CU, a CU-level flag is signalled to indicate whether TM is applied to both geometric partitions. Motion information for each geometric partition is refined using TM. When TM is chosen, a template is constructed using left, above or left and above neighbouring samples according to partition angle, as shown in Table 4. The motion is then refined by minimizing the difference between the current template and the template in the reference picture using the same search pattern of merge mode with half-pel interpolation filter disabled.

TABLE 4
Template for the 1st and 2nd geometric partitions using above samples
(A), left samples (L), and both left and above samples (L + A).

| Partition angle | 0 | 2 | 3 | 4 | 5 | 8 | 11 | 12 | 13 | 14 |
|---|---|---|---|---|---|---|---|---|---|---|
| 1^{st} partition | A | A | A | A | L + A | L + A | L + A | L + A | A | A |
| 2^{nd} partition | L + A | L + A | L + A | L | L | L | L | L + A | L + A | L + A |
| Partition angle | 16 | 18 | 19 | 20 | 21 | 24 | 27 | 28 | 29 | 30 |
| 1^{st} partition | A | A | A | A | L + A | L + A | L + A | L + A | A | A |
| 2^{nd} partition | L + A | L + A | L + A | L | L | L | L | L + A | L + A | L + A |

A GPM candidate list is constructed as follows:
1. Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates.
2. Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates.
3. Zero MV candidates are padded until the GPM candidate list is full.

The GPM-MMVD and GPM-TM are exclusively enabled to one GPM CU. This is done by firstly signalling the GPM-MMVD syntax. When both two GPM-MMVD control flags are equal to false (i.e., the GPM-MMVD are disabled for two GPM partitions), the GPM-TM flag is signalled to indicate whether the template matching is applied to the two GPM partitions. Otherwise (at least one GPM-MMVD flag is equal to true), the value of the GPM-TM flag is inferred to be false.

### Template Matching Based Reordering for GPM Split Modes

In template matching based reordering for GPM split modes, given the motion information of the current GPM block, the respective TM cost values of GPM split modes are computed. Then, all GPM split modes are reordered in ascending ordering based on the TM cost values. Instead of sending GPM split mode, an index using Golomb-Rice code to indicate where the exact GPM split mode located in the reordering list is signalled.

The reordering method for GPM split modes is a two-step process performed after the respective reference templates of the two GPM partitions in a coding unit are generated, as follows:
extending GPM partition edge into the reference templates of the two GPM partitions, resulting in 64 reference templates and computing the respective TM cost for each of the 64 reference templates;
reordering GPM split modes based on their TM cost values in ascending order and marking the best 32 split modes as available split modes.

The edge on the template is extended from that of the current CU, as shown in FIG. 15, but GPM blending process is not used in the template area across the edge. In FIG. 15, block 1510 corresponds to the current block, block 1520 corresponds to the top template and block 1530 corresponds to the left template.

After ascending reordering using TM cost, an index is signalled.

### Current Picture Referencing

Motion Compensation, one of the key technologies in hybrid video coding, explores the pixel correlation between adjacent pictures. It is generally assumed that in a video sequence the patterns corresponding to objects or background in a frame are displaced to form corresponding objects on the subsequent frame or correlated with other patterns within the current frame. With the estimation of such a displacement (e.g. using block matching techniques), the pattern can be mostly reproduced without needing to re-code the pattern. Similarly, block matching and copy has also been tried to allow selecting the reference block from within the same picture. It was observed to be not efficient when applying this concept to camera captured videos. Part of the reasons is that the textual pattern in a spatial neighbouring area may be similar to the current coding block but usually with some gradual changes over space. It is thus difficult for a block to find an exact match within the same picture of a camera captured video, therefore the improvement in coding performance is limited.

However, the spatial correlation among pixels within the same picture is different for screen content. For a typical video with text and graphics, there are usually repetitive patterns within the same picture. Hence, intra (picture) block compensation has been observed to be very effective. A new prediction mode, i.e., the intra block copy (IBC) mode or called current picture referencing (CPR), was thus introduced for screen content coding to utilize this characteristic. In the CPR mode, a prediction unit (PU) is predicted from a previously reconstructed block within the same picture. Further, a displacement vector (called block vector or BV) is used to signal the relative displacement from the position of the current block to that of the reference block. The prediction errors are then coded using transformation, quantization and entropy coding. An example of CPR compensation is illustrated in FIG. 16, where block 1612 is a corresponding block for block 1610, and block 1622 is a corresponding block for block 1620. In this technique, the reference samples correspond to the reconstructed samples of the current decoded picture prior to in-loop filter operations, both deblocking and sample adaptive offset (SAO) filters in HEVC.

When CPR is used, only part of the current picture can be used as the reference picture. A few bitstream conformance constraints are imposed to regulate the valid MV value referring to the current picture.

First, one of the following two must be true:

BV_x+offsetX+nPbSw+xPbs−xCbs<=0 (4)

BV_y+offsetY+nPbSh+yPbs−yCbs<=0 (5)

Second, the following WPP condition must be true:

(xPbs+BV_x+offsetX+nPbSw−1)/CtbSizeY−xCbs/CtbSizeY<=yCbs/CtbSizeY−(yPbs+BV_y+offsetY+nPbSh−1)/CtbSizeY (6)

In (4) through (6), (BV_x, BV_y) is the luma block vector (the motion vector for CPR) for the current PU; nPbSw and nPbSh are the width and height of the current PU; (xPbS, yPbs) is the location of the top-left pixel of the current PU relative to the current picture; (xCbs, yCbs) is the location of the top-left pixel of the current CU relative to the current picture; and CtbSizeY is the size of the CTU. OffsetX and offsetY are two adjusted offsets in two dimensions in consideration of chroma sample interpolation for the CPR mode.

offsetX=BVC_x &0×7?2:0 (7)

offsetY=BVC_y&0×7?2:0 (8)
(BVC_x, BVC_y) is the chroma block vector, in ⅛-pel resolution in HEVC.

Third, the reference block for CPR must be within the same tile/slice boundary.

IBC with Template Matching

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfilment is replaced by motion vectors to the left (−W, 0), top (0,−H) and top-left (−W,−H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signalled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

The Template Matching refinement for both IBC-TM merge and AMVP modes is quite simple since IBC motion vectors are constrained (i) to be integer and (ii) within a reference region as shown in FIG. 17, where IBC reference region depending on current CU position are shown for various cases (1710-1740). So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

### Multi-Pass Decoder-Side Motion Vector Refinement (MP-DMVR)

A multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### First Pass—Block Based Bilateral Matching MV Refinement

In the first pass, a refined MV is derived by applying BM to a coding block. Similar to decoder-side motion vector refinement (DMVR), in the bi-prediction operation, a refined MV is searched around the two initial MVs (i.e., MV0 and MV1) in the reference picture lists L0 and L1. The refined MVs (i.e., MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in the horizontal direction and [−sVer, sVer] in the vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, MRSAD cost function is applied to remove the DC effect of distortion between reference blocks. When the bilCost at the centre point of the 3×3 search pattern has the minimum cost, the intDeltaMV local search is terminated. Otherwise, the current minimum cost search point becomes the new centre point of the 3×3 search pattern and continue to search for the minimum cost, until it reaches the end of the search range.

The existing fractional sample refinement is further applied to derive the final deltaMV. The refined MVs after the first pass are then derived as:

MV0_pass1=MV0+deltaMV

MV1_pass1=MV1−deltaMV

### Second Pass—Subblock Based Bilateral Matching MV Refinement

In the second pass, a refined MV is derived by applying BM to a 16×16 grid subblock. For each subblock, a refined MV is searched around the two MVs (e.g. MV0_pass1 and MV1_pass1), obtained during the first pass, in the reference picture list L0 and L1. The refined MVs (i.e., MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in the horizontal direction and [−sVer, sVer] in the vertical direction, wherein, the values of sHor and sVer are determined by the block dimension, and the maximum value of sHor and sVer is 8.

The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions shown on FIG. 18, where the 5 search regions are shown in 5 different shades. Each search region is assigned a costFactor, which is determined by the distance (intDeltaMV) between each search point and the starting MV, and each diamond region is processed in the order starting from the centre of the search area. In each region, the search points are processed in the raster scan order starting from the top left going to the bottom right corner of the region. When the minimum bilCost within the current search region is less than a threshold equal to sbW*sbH, the int-pel full search is terminated; otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement is further applied to derive the final deltaMV (sbIdx2). The refined MVs at second pass is then derived as:

MV0_pass2(sbIdx2)=MV0_pass1+deltaMV(sbIdx2)

MV1_pass2(sbIdx2)=MV1_pass1−deltaMV(sbIdx2)

Third pass-Subblock based bi-directional optical flow MV refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (e.g. MV0_pass3(sbIdx3) and MV1_pass3(sbIdx3)) at third pass are derived as:

MV0_pass3(sbIdx3)=MV0_pass2(sbIdx2)+bioMv

MV1_pass3(sbIdx3)=MV0_pass2(sbIdx2)−bioMv

### Bilateral Matching AMVP-Merge Mode

The bi-directional predictor is composed of an AMVP predictor in one direction and a merge predictor in the other direction. The mode can be enabled to a coding block when the selected merge predictor and the AMVP predictor satisfy DMVR condition, where there is at least one reference picture from the past and one reference picture from the future relatively to the current picture and the distances from two reference pictures to the current picture are the same, the bilateral matching MV refinement is applied for the merge MV candidate and AMVP MVP as a starting point. Otherwise, if template matching functionality is enabled, template matching MV refinement is applied to the merge predictor or the AMVP predictor which has a higher template matching cost.

AMVP part of the mode is signalled as a regular uni-directional AMVP, i.e. reference index and MVD are signalled, and it has a derived MVP index if template matching is used or MVP index is signalled when template matching is disabled.

For AMVP direction LX, X can be 0 or 1, the merge part in the other direction (1−LX) is implicitly derived by minimizing the bilateral matching cost between the AMVP predictor and a merge predictor, i.e. for a pair of the AMVP and a merge motion vectors. For every merge candidate in the merge candidate list which has that other direction (1−LX) motion vector, the bilateral matching cost is calculated using the merge candidate MV and the AMVP MV. The merge candidate with the smallest cost is selected. The bilateral matching refinement is applied to the coding block with the selected merge candidate MV and the AMVP MV as a starting point.

The third pass of multi pass DMVR which is 8×8 sub-PU BDOF refinement of the multi-pass DMVR is enabled to AMVP-merge mode coded block.

The mode is indicated by a flag, if the mode is enabled AMVP direction LX is further indicated by a flag.

When bilateral matching (BM) AMVP-merge mode is used for the current block and template matching is enabled, MVD is not signalled. An additional pair of AMVP-merge MVPs is introduced. The merge candidate list is sorted based on the BM cost in increase order. An index (0 or 1) is signalled to indicate which merge candidate in the sorted merge candidate list to use. When there is only one candidate in merge candidate list, the pair of AMVP MVP and merge MVP without bilateral matching MV refinement is padded.

### MVD Sign Prediction in ECM

In this method, possible MVD sign combinations are sorted according to the template matching cost and index corresponding to the true MVD sign is derived and context coded. At decoder side, the MVD signs are derived as following:
1. Parse the magnitude of MVD components
2. Parse context coded MVD sign prediction index
3. Build MV candidates by creating combination between possible signs and absolute MVD value and add it to the MV predictor
4. Derive MVD sign prediction cost for each derived MV based on template matching cost and sort
5. Use MVD sign prediction index to pick the true MVD sign

MVD sign prediction is applied to inter AMVP, affine AMVP, MMVD and affine MMVD modes. Note, when wrap around motion compensation is enabled, the MV candidate shall be clipped with wrap around offset taken into consideration.

As described above, decoder-side motion vector derivation based on template matching is used in various video coding tools. In the present invention, prioritized initial motion vector is disclosed to decrease template matching cost associated with the initial motion vector so as to favour the initial motion vector during the motion vector refinement process.

### BRIEF SUMMARY OF THE INVENTION

A method and apparatus for video coding are disclosed. According to the method, input data associated with a current block are received, wherein the input data comprise pixel data for the current block to be encoded at an encoder side or data associated with the current block to be decoded at a decoder side. An initial MV (Motion Vector) for the current block is determined. One or more MV candidates are also determined. An initial TM cost associated with the initial MV is derived, wherein the initial TM cost comprises a first metric associated with a current template of the current block and a first template of a first reference block pointed by the initial MV. A modified initial TM cost is derived by adding an offset value to the initial TM cost. One or more candidate TM costs for said one or more MV candidates are determined, wherein said one or more candidate TM costs comprise one or more second metrics associated with the current template of the current block and one or more second templates respectively, and wherein each of said one or more second templates is associated with one second reference block pointed by one of said one or more MV candidates. The initial MV and said one or more MV candidates are reordered according to the modified initial TM cost and said one or more candidate TM costs.

In one embodiment, the offset value corresponds to a positive value or a negative value. In one embodiment, the offset value corresponds to a fixed value or the offset value is dependent on the initial TM cost. In one embodiment, the offset value is signalled or parsed from a bitstream. In one embodiment, the offset value is determined according to coding information. For example, the coding information comprises template area, QP (Quantization Parameters), or both, and wherein the template area is associated with the current template, the first template, said one or more second templates, or a combination thereof.

In one embodiment, said one or more MV candidates are associated with inter directions of motion compensation and the inter directions of motion compensation comprise uni-directional L0 prediction, uni-directional L1 prediction, bi-directional prediction, more than two hypothesis predictions, or a combination thereof, and if one MV candidate has a same inter direction as the initial MV, a corresponding TM cost for said one MV candidate is decreased by a second offset value and the second offset value corresponds to a positive value.

In one embodiment, said one or more MV candidates are associated with weights for BCW (Bi-prediction with CU-level weight), and if one MV candidate has same weights for BCW as the initial MV, a corresponding TM cost for said one MV candidate is decreased by a second offset value and the second offset value corresponds to a positive value.

In one embodiment, each of said one or more candidate TM costs further comprises a weighted candidate MV difference between the initial MV and one of said one or more MV candidates. In one embodiment, a weighting factor for the weighted candidate MV difference corresponds to a fixed value or is dependent on coding information. In another embodiment, a weighting factor for the weighted candidate MV difference is pre-defined, or explicitly signalled or parsed from a bitstream.

In one embodiment, the first metric and said one or more second metrics correspond to SAD (Sum of Absolute Differences), SSD (Sum of Squared Differences), or SATD (Sum of Absolute Transformed Differences).

According to another method, input data associated with a current block are received, wherein the input data comprise pixel data for the current block to be encoded at an encoder side or data associated with the current block to be decoded at a decoder side. An initial MV (Motion Vector) for the current block is determined. One or more MV candidates are also determined. An initial TM cost associated with the initial MV is derived based on a current template of the current block and a first template of a first reference block pointed by the initial MV. One or more candidate TM costs for said one or more MV candidates are determined based on the current template of the current block and one or more second templates respectively, and wherein each of said one or more second templates is associated with one second reference block pointed by one of said one or more MV candidates. One or more weighted candidate TM costs are derived, wherein each of said one or more weighted candidate TM costs is derived by weighting one of said one or more candidate TM costs by a weighting factor and the weighting factor is larger for a target MV candidate further away from the initial MV or deriving one or more modified candidate TM costs by reducing one or more target candidate TM costs with smaller step sizes by an offset value. The initial MV and said one or more MV candidates are reordered according to the initial TM cost and said one or more weighted candidate TM costs or according to the initial TM cost and said one or more modified candidate TM costs.

In one embodiment, said one or more MV candidates comprise inter and affine MMVD (Merge Mode with Motion Vector Difference) candidates with corresponding step size and directions.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates the four splitting types in multi-type tree structure including vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 3 illustrates an example of dividing a CTU into multiple CUs with a quadtree and nested multi-type tree coding block structure, where the bold block edges represent quadtree partitioning and the remaining edges represent multi-type tree partitioning.

FIG. 4 illustrates an example of Merge Mode with MVD (MMVD) with pre-defined offset from the starting points for an L0 reference block and L1 reference block.

FIGS. 5A-B illustrates examples of the affine motion field for a current block, where the motion is described by motion information of two control point (4-parameter) in FIG. 5A or three control point motion vectors (6-parameter) in FIG. 5B.

FIG. 6 illustrates an example of block based affine transform prediction, where the motion vector of each 4×4 luma subblock is derived according to the affine motion model.

FIG. 7 shows the spatial neighbouring candidate blocks used to derive inherited affine candidates.

FIG. 8 illustrates an example of deriving control-point MVP for an affine-coded current block, where a neighbouring CU on the left is also coded in the affine mode.

FIG. 9 illustrates an example of constructing affine candidate by combining the neighbouring translational motion information of each control point.

FIG. 10 illustrates an example of Decoder Side Motion Vector Refinement (DMVR) in VVC.

FIG. 11 illustrates the partition patterns according to Geometric Partitioning Mode (GPM), where a CU is split into two parts by a geometrically located straight line.

FIG. 12 shows the top and left neighbouring blocks used for calculating the weight for Combined Inter and Intra Prediction (CIIP).

FIG. 13 illustrates an example of template matching (TM) used in a decoder-side MV derivation method to refine the motion information of the current CU.

FIG. 14 illustrates an example of template matching based OBMC, where for each left block with a size of 4×4 at the left CU boundary, the left template size equals to 1×4 or 1×4N. Similar process is also applied to each top block with a size of 4×4 at the top CU boundary.

FIG. 15 illustrates an example of template matching based reordering for GPM split modes, where the edge on the template is extended from that of the current CU.

FIG. 16 illustrates an example of CPR (current reference picture) compensation.

FIG. 17 illustrates examples of IBC motion vectors constraints for IBC with template matching.

FIG. 18 shows the 5 diamond shape search regions used in the second-pass bilateral matching MV refinement during the Multi-Pass Decoder-Side Motion Vector Refinement (MP-DMVR).

FIG. 19 illustrates an example of MVD candidate reordering by motion vector matching according to an embodiment of the present invention.

FIG. 20 illustrates a flowchart of an exemplary video coding system that uses prioritized initial MV according to an embodiment of the present invention.

FIG. 21 illustrates a flowchart of another exemplary video coding system that uses prioritized initial MV according to an embodiment of the present invention

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The concept of the Template Matching (TM) is to refine an initial MV by performing template matching at the decoder, where the template is a predefined region formed by the reconstructed luma and/or chroma samples as illustrated in FIG. 13. Based on an initial MV, the template points to a corresponding reference block in the reference picture.

Various matching metrics (or termed similarity measurement, or matching cost) can be used to evaluate the similarity between the template and the reference block. The matching metrics may include, but not limited to, the Sum of Absolute Difference (SAD), Sum of Squared Error (SSE) and Sum of Transformed Difference (SATD). Starting with the initial MV, the template matching is performed to search for a best matched reference block in the reference picture within a predefined search range. After all the predefined search points are accessed and the corresponding matching metrics are all calculated, the motion vector between the template and the best matched reference block (e.g. the reference block has the smallest matching cost against the template) is regarded as a refined motion vector.

The TM process is utilized to refine the motion vector (MV) based on a given initial motion vector at the decoder side. Since the motion vector refinement is done at the decoder side, it is not guaranteed that the refined motion vector derived by the TM process is always better than the initial MV in terms of the accuracy of the motion compensation (MC) prediction. Moreover, the initial MV is somehow reliable because it is derived from the previously block. In this invention, several methods are proposed to let TM process favour the initial MV.

In this invention, several methods are proposed to improve the TM. It is noted that the term “block” in this invention can be a coding unit (CU), coding block (CB), prediction unit (PU), prediction block (PB), transform unit (TU), transform block (TB) or a block of any size.

In the first embodiment of this invention, the cost of the initial MV in the TM motion refinement process is reduced by an offset value. The offset value can be a fixed value or a ratio of the TM cost of the initial MV (e.g. 1/16 of the TM cost of the initial MV). This offset value can be determined by at least one syntax elements signalled in the bitstreams at video level (e.g. video parameter set), sequence level (e.g. sequence parameter set), picture level (e.g, picture parameter set, picture header), slice level (e.g. slice header), coding tree unit (CTU)), and/or block level (e.g. prediction unit, transform unit).

In the second embodiment of this invention, the cost of the initial MV in the TM motion refinement process is reduced by an offset value. The offset value can be a fixed value or a ratio of the TM cost of the initial MV (e.g. 1/16 of the TM cost of the initial MV). This offset value can be determined according to the coding information.

In one example, the offset value is determined according to the area of the template as illustrated below.

```
If template area is smaller than TH_1
  The offset value is set to 1/N_1 of the TM cost of the initial MV
Else if template area is smaller than TH_2
  The offset value is set to 1/N_2 of the TM cost of the initial MV
Else if template area is smaller than TH_3
  The offset value is set to 1/N_3 of the TM cost of the initial MV
  ...
  ...
    ...
Else if template area is smaller than TH_M Signal the
  The offset value is set to 1/N_M of the TM cost of the initial MV
Else
  The offset value is set to 1/N M+1 of the TM cost of the initial MV
Endif
```

In yet another example, the offset value is determined according to the QP used by the current block as illustrated below.

```
If QP of the current block is smaller than TH_1
  The offset value is set to 1/N_1 of the TM cost of the initial MV
Else if QP of the current block is smaller than TH_2
  The offset value is set to 1/N_2 of the TM cost of the initial MV
Else if QP of the current block is smaller than TH_3
  The offset value is set to 1/N_3 of the TM cost of the initial MV
  ...
  ...
  ...
Else if QP of the current block is smaller than TH_M
  The offset value is set to 1/N_M of the TM cost of the initial MV
Else
  The offset value is set to 1/N_M+1 of the TM cost of the initial MV
Endif
```

This offset values (e.g. N_1, N_2, . . . , N_M in the above embodiment) can be predefined or can be determined by at least one syntax elements signalled in the bitstreams at video level (e.g. video parameter set), sequence level (e.g. sequence parameter set), picture level (e.g. picture parameter set, picture header), slice level (e.g. slice header), Coding Tree Unit (CTU)), and/or block level (e.g. prediction unit, transform unit).

It is worth noticing that the refined cost can be modified in a similar way but increased, instead of decreasing the unrefined/initial cost. Mathematically it will be equivalent to decreasing the initial cost, however it may be written both ways.

In the third embodiment of this invention, the matching cost of the TM motion refinement process is modified to be the similarity measurement cost (e.g. SAD, SSD (Sum of Squared Differences), SATD (Sum of Absolute Transformed Differences)) plus the weighted MV difference where the MV difference is calculated as the difference between the initial MV and the MV of each search point within the TM refinement. The difference between two MVs is calculated as the absolute difference between the x-components (or horizontal component) of the two MVs plus the absolute difference between the y-components (or vertical component) of the two MVs. The weighting factor can be a fixed value or an adaptive factor based on the coding information such as QP. Moreover, the weighting factor can be predetermined or explicitly signalled in the bitstream.

In another embodiment, weighting/cost factor for refinements can be position dependent. In one embodiment, a refinement which is further away from the initial MV has higher weighting used for the cost (or lower threshold used when the cost is compared and decided whether to be added in the list), similar to the second pass of MP-DMVR. This way, the further TM-based MV refinement goes from the initial unrefined MV, the higher the coefficient used for its cost. This way, the initial MV is not explicitly preferred. However, the refinements closer to the initial MV, would have lower cost factor compared to those which are farther, and the closer refinements are preferred. This method can be combined together with one of the ways to decrease the cost of the initial unrefined MV.

In another embodiment, when TM cost is used to determine the inter direction for motion compensation among uni-directional L0 prediction, uni-directional L1 prediction, bi-directional prediction, and/or more than 2 hypothesis predictions, the cost of the MV candidate having the same inter direction as the initial MV candidate is reduced by an offset value (e.g., 1/16 of the TM cost of the initial MV candidate). It is noted that the inter-direction is also termed as the inter prediction indicator. Specifically, when the initial MV candidate is a uni-directional L0 prediction, the TM costs of the MV candidates which are uni-directional L0 predicted are reduced by an offset value. Similarly, when the initial MV candidate is a bi-directional prediction, the TM costs of the MV candidates which are bi-directional predicted are reduced by an offset value.

In one example, when the MV candidate is a bi-directional prediction, the TM cost of a bi-directional MV candidate can be calculated by performing bi-directional motion compensation for the template using both the L0 and L1 MVs. The TM cost is then calculated based on the bi-directional predictors and the template. The TM cost of the uni-directional L0/L1 MV candidates are calculated based on the uni-directional L0/L1 predictors and the template. After the bi-directional TM cost and the uni-directional L0/L1 TM cost are all available, the inter direction for motion compensation among uni-directional L0 prediction, uni-directional L1 prediction, bi-directional prediction can be determined based on their TM costs. Specifically, the MV candidate with the inter-direction having the smallest TM cost is selected by the current block. Assuming the initial MV candidate is a bi-directional MV, the TM costs of the MV candidates which are bi-directional predicted are reduced by an offset value and are than compared to the other MV candidates.

In another embodiment, when TM cost is used to determine the BCW weightings. the cost of the MV candidate having the same BCW as the initial MV candidate is reduced by an offset value (e.g., 1/16 of the TM cost of the initial MV candidate). It is noted that BCW supports various weights to average the L0 and L1 motion compensation predictors. Specifically, when the initial MV candidate utilizes an equal weights BCW, the TM costs of the MV candidates using equal weights BCW are reduced by an offset value.

In one example, when the MV candidate is a bi-directional prediction, the BCW TM costs of the MV candidate can be calculated by performing bi-directional motion compensation for the template using both the L0 and L1 MVs with different BCW weightings. Assuming the initial BCW weight is inherited from a neighbouring BCW weight, the TM cost of the MV candidate with inherited BCW weight is reduced by an offset value and is then compared to the other MV candidates. In another example, the initial BCW weight can be equal BCW weight.

In another embodiment, when TM cost is used to determine the inter direction for motion compensation among uni-directional L0 prediction, uni-directional L1 prediction, bi-directional prediction, and/or more than 2 hypothesis predictions, the initial MV candidate is determined by the inherited BCW weight. Specifically, when the inherited BCW weight is equal weight, the initial MV candidate is determined to be bi-prediction. Otherwise, when the inherited BCW weight is unequal weight, the initial MV candidate is determined to be uni-prediction with a higher BCW weight. That is, if the BCW weight of L0 is higher, then the initial MV candidate is L0 uni-prediction. The TM cost of the initial MV candidate is reduced by an offset value (e.g., 1/16 of the TM cost of the initial MV candidate).

In another embodiment, when TM cost is used to determine the signalling orders of inter and affine MMVD candidates, all the inter and affine MMVD candidates with corresponding step sizes and directions are reordered by the TM costs. In one example, the TM costs of the candidates with smaller step size are reduced by an offset value (e.g., 1/16 of the TM cost of the initial MV candidate). In another example, the base MV of inter or affine MMVD is refined by TM to derive TM refined base MV. The TM costs of the candidates with the directions same as the MVD direction from original base MV to TM refined base MV are reduced by an offset value (e.g., 1/16 of the TM cost of the initial MV candidate).

As illustrated in the previous paragraphs, TM is not only used to refine the motion vector predictor for the inter mode and refine the merge candidates, but TM is also used on many other coding tools to improve their prediction efficiency such as OBMC, IBC and so on, In the third embodiment of this invention, the proposed methods in this invention can be selectively applied to the TM applying coding tools.

Any of the foregoing proposed methods can be applied independently or jointly. Moreover, any of the foregoing proposed methods can be implemented in encoders and/or decoders. For example, any of the proposed methods can be implemented in inter prediction module of an encoder and/or a decoder. Alternatively, any of the proposed methods can be implemented as a circuit coupled to inter prediction module of the encoder and/or the decoder.

### Motion Vector Difference Candidate Reordering by Motion Vector Matching

In ECM, when motion vector difference (MVD) is coded, the sign bits are context coded by reordering the MVD candidates based on template matching (TM). In JVET-AC0239( ) the suffix bins of exponential Golomb code of MVD magnitude could also be context coded by TM-based reordering. However, in these methods, a large region of reference frame needs to be fetched at the decoder side for performing TM, which may be an issue in terms of implementation. Some methods are proposed to resolve such issue.

In one embodiment, a motion vector matching cost is used to replace the TM cost in the MVD sign/suffix prediction algorithm, where the motion vector matching cost is derived by calculating the difference between the candidate motion vector (candMV) and a reference motion vector (refMV). Specifically, the candMV is the motion vector predictor plus one of the possible MVD candidates for reordering.

Example 1. The refMV is the inverse scaled motion vector of the reference block pointed by the candMV.

An illustration of this example is shown in FIG. 19. Given a to-be-reordered MVD candidate MVD0 1960, which corresponds to a candidate motion vector candMV0 1950. Assume that candMV0 1950 points to a reference block B0. Consider the motion vector of B0 and scale the motion vector to the current frame to obtain “scaled MV of B0 1944” in reference picture 1920. The motion vector matching cost of MVD0 is derived by calculating the distance (i.e., do in the figure) between the current position 1914 of the current block 1912 and the position 1916 pointed by the “scaled MV of B0 1944”. Similarly, the motion vector matching cost of MVD1 is derived by calculating the distance (i.e., d1 in the figure) between the current position 1914 of the current block 1912 and the position 1918 pointed by the “scaled MV of B1 1946”. When performing reordering, if the matching cost of MVD0 1960 is smaller than that of MVD1 1962 as the figure shows (d0<d1), MVD0 1960 will be put at a former order than MVD1 1962. In FIG. 19, reference block 1932 of B0 and reference block 1934 of B1 in reference picture 1930 of reference picture 1920 are shown. The reference block 1932 of B0 is located based on the location of B0 and the MV1940 of B0, and the reference block 1934 of B1 is located based on the location of B1 and the MV1942 of B1. MVP0 1954 corresponds to the MV Prediction 0.

Note that there is another aspect of this example. The matching cost for MVD0 can be derived by calculating the difference between the candMV0 and the inverse of the “scaled MV of B0,” resulting in the same distance do.

It is possible that the reference blocks B0 and B1 cover more than one coding units, resulting in more than one available motion vectors for “MV of B0” and “MV of B1.” In such case, some criteria can be used to select the motion vectors. For example, the motion vector of the top-left coding unit is always used. For another example, the motion vector of the coding unit with the largest area covered by the reference block is used. After selecting the motion vector, the top-left position should be moved accordingly when calculating the matching cost.

Example 2. The refMV is scaled motion vector from a neighbouring block.

In this example, it is assumed that a candMV is more reliable if it is similar to the motion vector of a neighbouring block. The neighbouring block can be the top or left block that is already coded. Note that motion vector can be scaled according to the temporal distances if the reference frame of candMV and the reference frame of MV of the neighbouring block are different.

Example 3. The refMV is scaled motion vector from a collocated block.

Example 4. If bi-prediction is used, MVD sign/suffix prediction is only applied to one side. The refMV is the scaled motion vector from another side.

Example 5. If bi-prediction is used, MVD sign/suffix prediction is applied to both sides. The bilateral motion vector matching is used for reordering the MVD candidates. That is, candMV of a side is the refMV for the other side.

In this example, assume there are 2 MVD candidates for each side.
L0: candMV00, candMV01
L1: candMV10, candMV11

A total number of 4 motion vector matching costs, (candMV00, candMV10), (candMV00, candMV11), (candMV01, candMV10), and (candMV01, candMV11), will be calculated, and the pair with lower matching cost will be considered more reliable.

In the above embodiment, if the refMV is not available, a default refMV can be used instead.

In the above embodiment, if the refMV is not available, a refMV derived by using another example can be used instead. For example, if there is no refMV for one candMV in Example 1 since there is no motion vector for the reference block, the refMV in Example 2 can be used.

In another embodiment, multiple refMVs are used to determine the motion vector matching cost. For example, refMV1 and refMV2 are reference motion vectors derived by using the methods described in Example 1 and Example 2 above. The average of these two refMVs is used to calculate the matching cost with candMV.

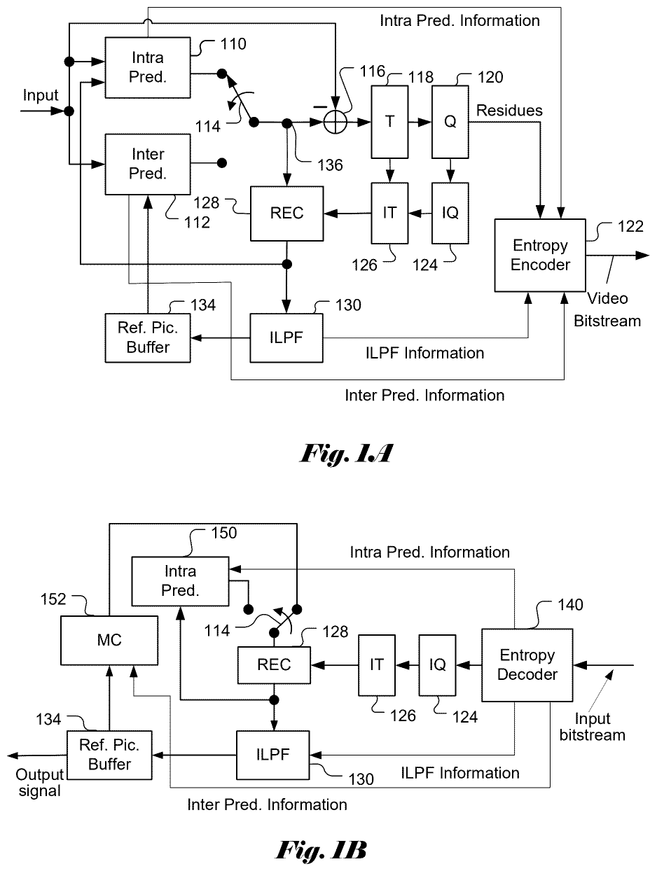

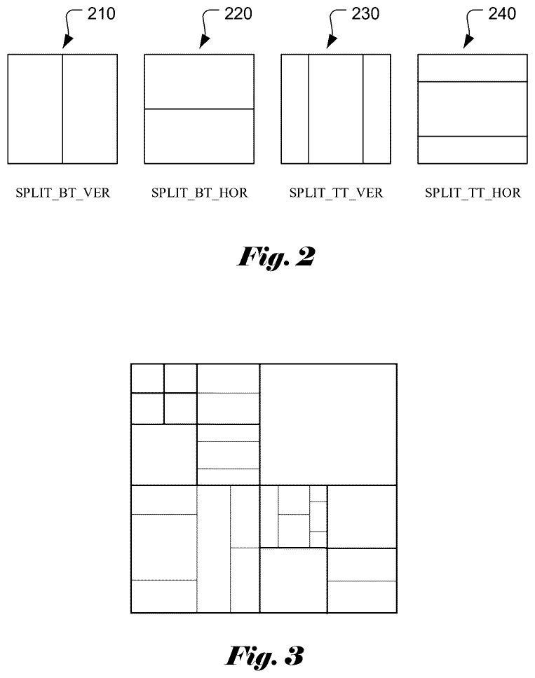

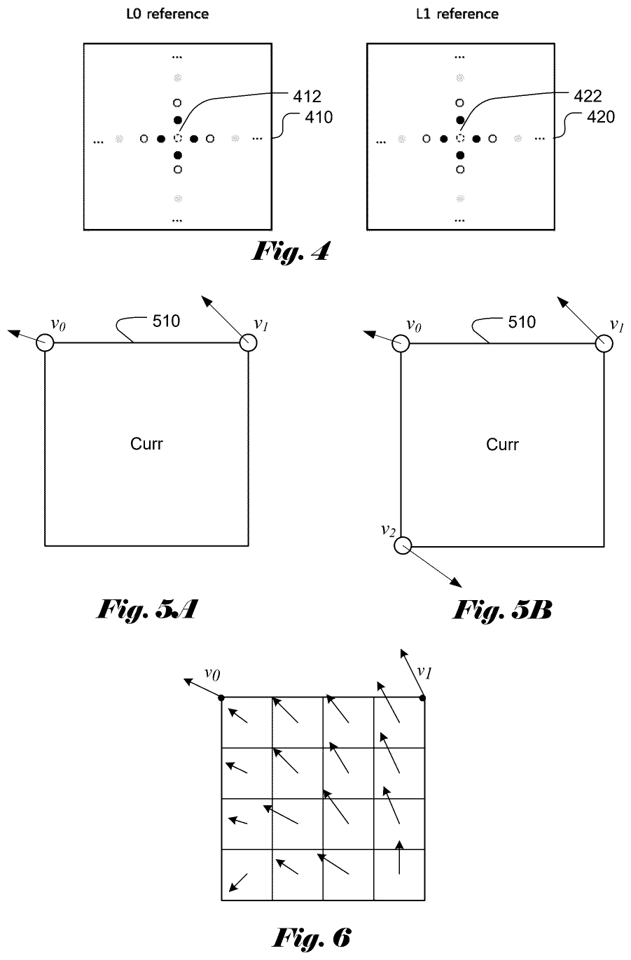

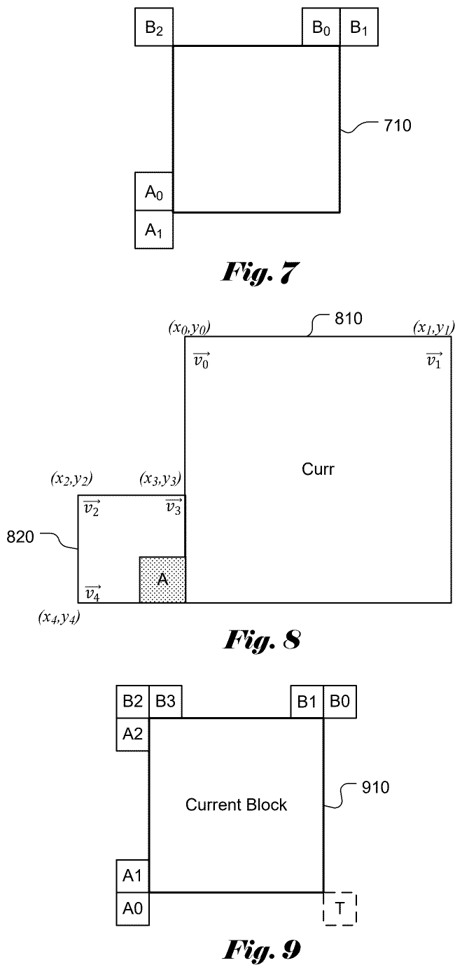

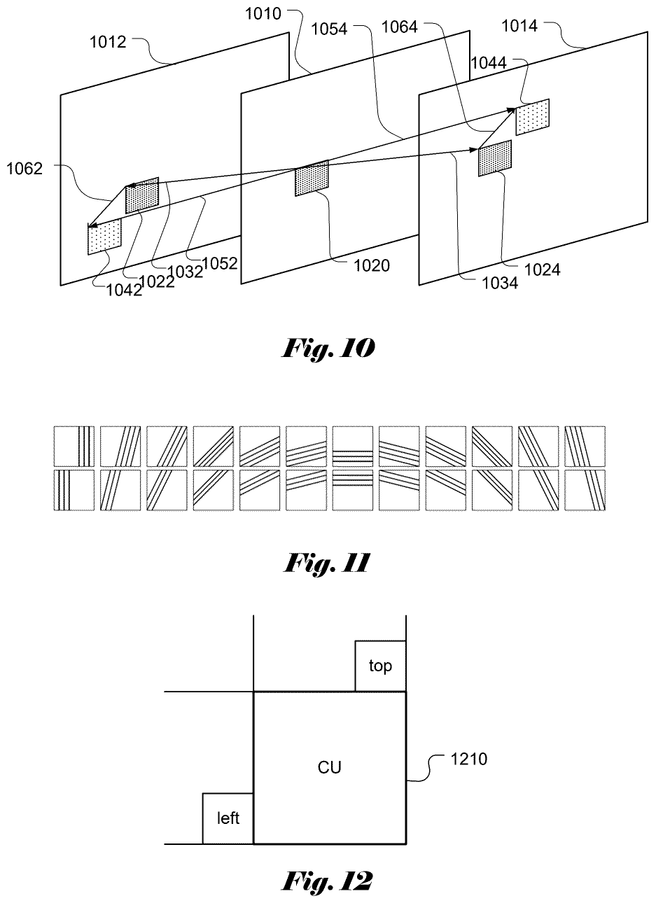

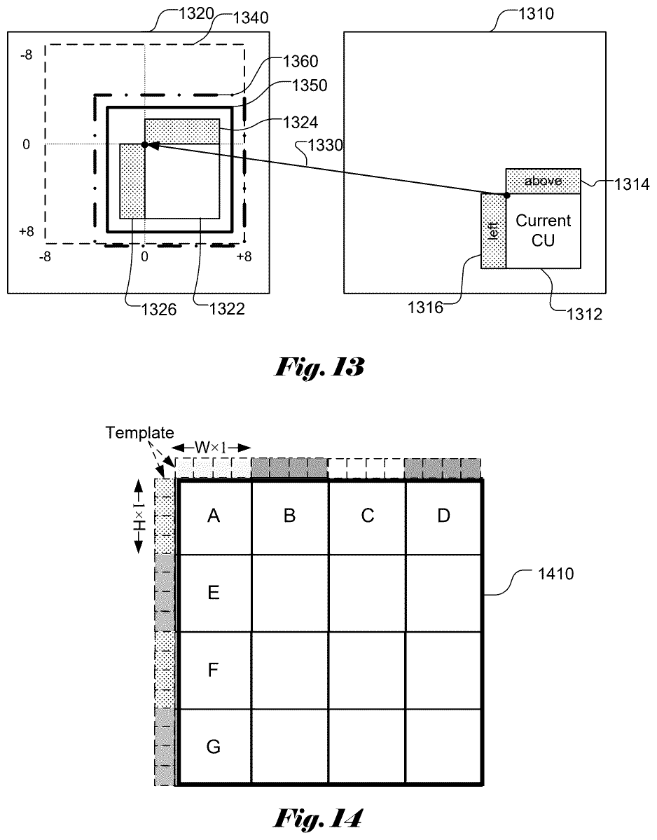

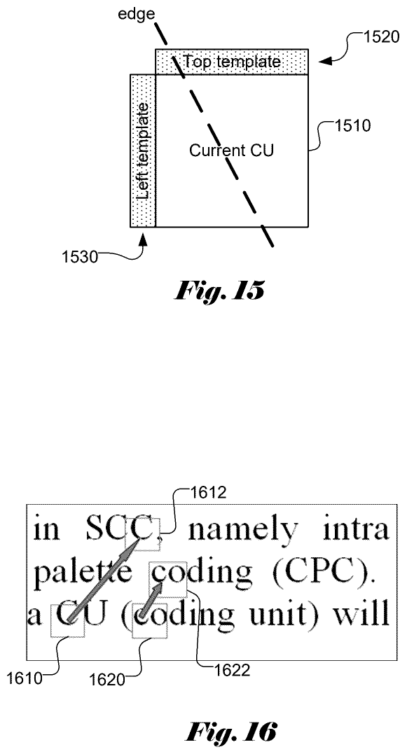

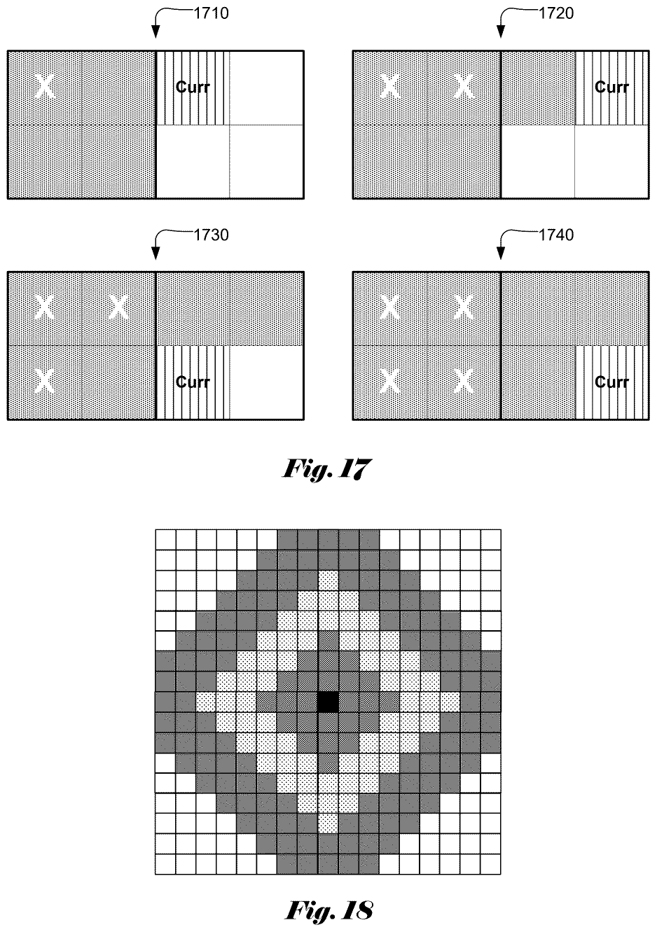

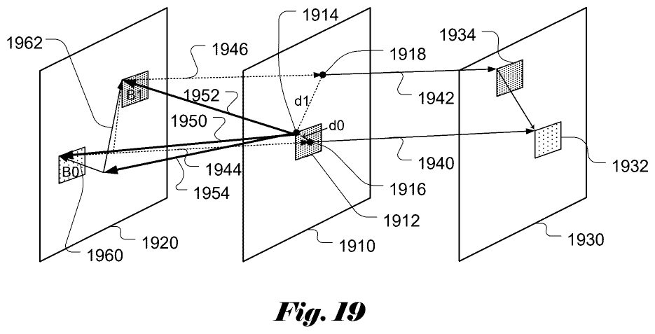

The prioritized initial MV for MV candidates reordering as described above can be implemented in an encoder side or a decoder side. For example, any of the proposed prioritized initial MV methods can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed shared buffer to store coding information among multiple coding tools including the CCM mode can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

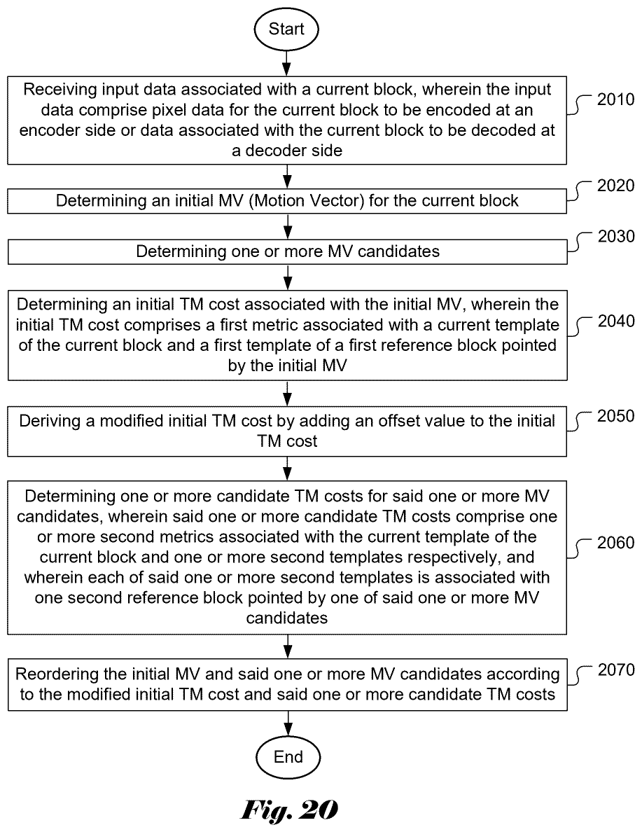

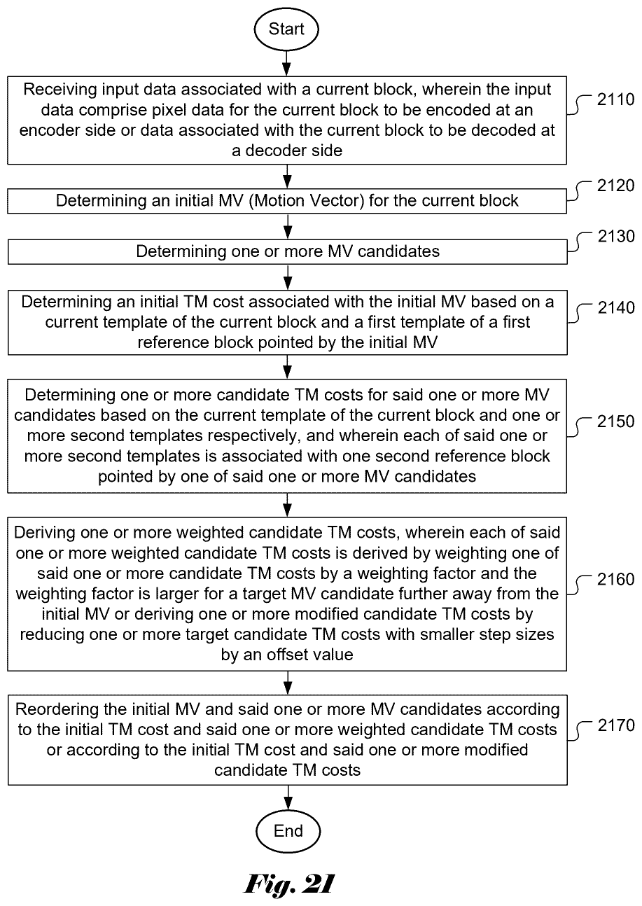

FIG. 20 illustrates a flowchart of an exemplary video coding system that uses prioritized initial MV according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block are received in step 2010, wherein the input data comprise pixel data for the current block to be encoded at an encoder side or data associated with the current block to be decoded at a decoder side. An initial MV (Motion Vector) for the current block is determined in step 2020. One or more MV candidates are also determined in step 2030. An initial TM cost associated with the initial MV is derived in step 2040, wherein the initial TM cost comprises a first metric associated with a current template of the current block and a first template of a first reference block pointed by the initial MV. A modified initial TM cost is derived by adding an offset value to the initial TM cost in step 2050. One or more candidate TM costs for said one or more MV candidates are determined in step 2060, wherein said one or more candidate TM costs comprise one or more second metrics associated with the current template of the current block and one or more second templates respectively, and wherein each of said one or more second templates is associated with one second reference block pointed by one of said one or more MV candidates. The initial MV and said one or more MV candidates are reordered according to the modified initial TM cost and said one or more candidate TM costs in step 2070.

FIG. 21 illustrates a flowchart of another exemplary video coding system that uses prioritized initial MV according to an embodiment of the present invention. According to another method, input data associated with a current block are received in step 2110, wherein the input data comprise pixel data for the current block to be encoded at an encoder side or data associated with the current block to be decoded at a decoder side. An initial MV (Motion Vector) for the current block is determined in step 2120. One or more MV candidates are also determined in step 2130. An initial TM cost associated with the initial MV is derived based on a current template of the current block and a first template of a first reference block pointed by the initial MV in step 2140. One or more candidate TM costs for said one or more MV candidates are determined based on the current template of the current block and one or more second templates respectively, and wherein each of said one or more second templates is associated with one second reference block pointed by one of said one or more MV candidates in step 2150. One or more weighted candidate TM costs are derived, wherein each of said one or more weighted candidate TM costs is derived by weighting one of said one or more candidate TM costs by a weighting factor and the weighting factor is larger for a target MV candidate further away from the initial MV or deriving one or more modified candidate TM costs by reducing one or more target candidate TM costs with smaller step sizes by an offset value in step 2160. The initial MV and said one or more MV candidates are reordered according to the initial TM cost and said one or more weighted candidate TM costs or according to the initial TM cost and said one or more modified candidate TM costs in step 2170.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data for the current block to be encoded at an encoder side or data associated with the current block to be decoded at a decoder side;
determining an initial MV (Motion Vector) for the current block;
determining one or more MV candidates;
deriving an initial TM cost associated with the initial MV, wherein the initial TM cost comprises a first metric associated with a current template of the current block and a first template of a first reference block pointed by the initial MV;
deriving a modified initial TM cost by adding an offset value to the initial TM cost;
determining one or more candidate TM costs for said one or more MV candidates, wherein said one or more candidate TM costs comprise one or more second metrics associated with the current template of the current block and one or more second templates respectively, and wherein each of said one or more second templates is associated with one second reference block pointed by one of said one or more MV candidates; and
reordering the initial MV and said one or more MV candidates according to the modified initial TM cost and said one or more candidate TM costs.

2. The method of claim 1, wherein the offset value corresponds to a positive value or a negative value.

3. The method of claim 1, wherein the offset value corresponds to a fixed value or the offset value is dependent on the initial TM cost.

4. The method of claim 1, wherein the offset value is signalled or parsed from a bitstream.

5. The method of claim 1, wherein the offset value is determined according to coding information.

6. The method of claim 5, wherein the coding information comprises template area, QP (Quantization Parameters), or both, and wherein the template area is associated with the current template, the first template, said one or more second templates, or a combination thereof.

7. The method of claim 1, wherein said one or more MV candidates are associated with inter directions of motion compensation and the inter directions of motion compensation comprise uni-directional L0 prediction, uni-directional L1 prediction, bi-directional prediction, more than two hypothesis predictions, or a combination thereof, and if one MV candidate has a same inter direction as the initial MV, a corresponding TM cost for said one MV candidate is decreased by a second offset value and the second offset value corresponds to a positive value.

8. The method of claim 1, wherein said one or more MV candidates are associated with weights for BCW (Bi-prediction with CU-level weight), and if one MV candidate has same weights for BCW as the initial MV, a corresponding TM cost for said one MV candidate is decreased by a second offset value and the second offset value corresponds to a positive value.

9. The method of claim 1, wherein each of said one or more candidate TM costs further comprises a weighted candidate MV difference between the initial MV and one of said one or more MV candidates.

10. The method of claim 9, wherein a weighting factor for the weighted candidate MV difference corresponds to a fixed value or is dependent on coding information.

11. The method of claim 9, wherein a weighting factor for the weighted candidate MV difference is pre-defined, or explicitly signalled or parsed from a bitstream.

12. The method of claim 1, wherein the first metric and said one or more second metrics correspond to SAD (Sum of Absolute Differences), SSD (Sum of Squared Differences), or SATD (Sum of Absolute Transformed Differences).

13. An apparatus for video coding, the apparatus comprising one or more electronics or processors arranged to:
receive input data associated with a current block, wherein the input data comprise pixel data for the current block to be encoded at an encoder side or data associated with the current block to be decoded at a decoder side;
determine an initial MV (Motion Vector) for the current block;
determine one or more MV candidates;
derive an initial TM cost associated with the initial MV, wherein the initial TM cost comprises a first metric associated with a current template of the current block and a first template of a first reference block pointed by the initial MV;
derive a modified initial TM cost by adding an offset value to the initial TM cost;
determine one or more candidate TM costs for said one or more MV candidates, wherein said one or more candidate TM costs comprise one or more second metrics associated with the current template of the current block and one or more second templates respectively, and wherein each of said one or more second templates is associated with one second reference block pointed by one of said one or more MV candidates; and
reordering the initial MV and said one or more MV candidates according to the modified initial TM cost and said one or more candidate TM costs.

14. A method of video coding, the method comprising:
receiving input data associated with a current block, wherein the input data comprise pixel data for the current block to be encoded at an encoder side or data associated with the current block to be decoded at a decoder side;
determining an initial MV (Motion Vector) for the current block;
determining one or more MV candidates;
deriving an initial TM cost associated with the initial MV based on a current template of the current block and a first template of a first reference block pointed by the initial MV;
determining one or more candidate TM costs for said one or more MV candidates based on the current template of the current block and one or more second templates respectively, and wherein each of said one or more second templates is associated with one second reference block pointed by one of said one or more MV candidates;
deriving one or more weighted candidate TM costs, wherein each of said one or more weighted candidate TM costs is derived by weighting one of said one or more candidate TM costs by a weighting factor and the weighting factor is larger for a target MV candidate further away from the initial MV or deriving one or more modified candidate TM costs by reducing one or more target candidate TM costs with smaller step sizes by an offset value; and
reordering the initial MV and said one or more MV candidates according to the initial TM cost and said one or more weighted candidate TM costs or according to the initial TM cost and said one or more modified candidate TM costs.

15. The method of claim 14, wherein said one or more MV candidates comprise inter and affine MMVD (Merge Mode with Motion Vector Difference) candidates with corresponding step size and directions.

16. An apparatus for video coding, the apparatus comprising one or more electronics or processors arranged to:
receive input data associated with a current block, wherein the input data comprise pixel data for the current block to be encoded at an encoder side or data associated with the current block to be decoded at a decoder side;
determine an initial MV (Motion Vector) for the current block;
determine one or more MV candidates;
deriving an initial TM cost associated with the initial MV based on a current template of the current block and a first template of a first reference block pointed by the initial MV;
determine one or more candidate TM costs for said one or more MV candidates based on the current template of the current block and one or more second templates respectively, and wherein each of said one or more second templates is associated with one second reference block pointed by one of said one or more MV candidates;
derive one or more weighted candidate TM costs, wherein each of said one or more weighted candidate TM costs is derived by weighting one of said one or more candidate TM costs by a weighting factor and the weighting factor is larger for a target MV candidate further away from the initial MV or deriving one or more modified candidate TM costs by reducing one or more target candidate TM costs with smaller step sizes by an offset value; and
reorder the initial MV and said one or more MV candidates according to the initial TM cost and said one or more weighted candidate TM costs or according to the initial TM cost and said one or more modified candidate TM costs.
